(19) United States
(12) Patent Application Publication
(10) Pub. No.: US 2008/0202346 A1
(43) Pub. Date: Aug. 28, 2008

(54) Tea maker with agitator

(76) Inventors: Mario Bernardo Accumanno, East Hanover, NJ (US); Michael William Crowley, Callabash, NC (US); Richard Chang, HSi Chih Town (TW); Juan Fernandez, Towaco, NJ (US)

Correspondence Address: Gearhart Law, LLC, 4 Ferndale Rd., Chatham, NJ, 07928, US

(21) Appl. No.: 11/985,964

(22) Filed: Nov. 19, 2007

Related U.S. Application Data
(63) Continuation-in-part of application No. 11/707,573, filed on Feb. 16, 2007.

(51) Int. Cl. A47J 31/06; A47J 31/18

(52) U.S. Cl. 99/280; 99/283; 99/287

(57) ABSTRACT

A tea maker, having a receptacle supported by a base, the receptacle being suitable for receiving water from a user and suitable for containing tea leaves, an actuatable valve having open and closed positions flowably connected to said receptacle; and a timer mechanism which sets the acuatable valve into the open position after a predetermined period set by the user, thereby allowing brewed tea to flow from the receptacle into a tea vessel. The invention further comprises a tea maker which has an agitation assembly which enhances the flavor and health benefits of the tea.

### PRIORITY CLAIM

This application is a continuation in part of U.S. Ser. No. 11/707,573 filed Mar. 16, 2007, which is incorporated herein by reference.

### FIELD OF THE INVENTION

The invention relates to infusion beverage makers, in particular, a single cup tea maker suitable for brewing tea for a user determined length of time.

### BACKGROUND OF THE INVENTION

The present invention relates to an infusion beverage maker comprising a receptacle for containing hot water, a timer mechanism for maintaining the hot water in contact with tea leaves for a predetermined period of time, said receptacle unit being detachably mounted on the base of the infusion beverage maker, and the timer mechanism having an actuatable valve assembly unit which controls the discharge of the infusion beverage into a vessel.

When making tea, as is known, the quality of the tea beverage depends on how long the tea leaves remain in the hot water, i.e., for how long the tea will draw. This is because up to roughly three minutes of infusion time, the tea will emit substances to the water which stimulates the circulation of a tea drinker after the consumption. When the tea stands for longer than three minutes, active substances are set free in the tea leaves which will reduce the circulation of a consumer upon consumption, which contributes to calming him or her down. Thus, controlling the time the tea brews is crucial, not only to the strength of the brew and the tea flavor, but on the medicinal effects felt by the tea drinker.

The tea maker has an optional removable basket/strainer to prevent tea leaves from stuffing up the outlet of the actuatable valve assembly, and to allow easy removal after use. Tea leaves can remain in the tea maker for one or more uses depending on the preference of the user. The basket can be removed, cleaned, and new tea leaves can be placed therein.

In addition, depending on the preference of the user, the receptacle assembly can be removed from the timer mechanism/base. Since the optimal cup of tea requires a clean brewing unit, removing the receptacle from the timer/mechanism base allows it to be cleaned, such as in a dishwasher, at regular intervals. As such, the user can maintain the unit free of residues that will ruin the flavor of the tea.

The removable receptacle assembly can be filled with hot water at one location and transported to the timer mechanism/base located elsewhere. A valve in the receptacle assembly closes when the receptacle assembly is removed from the timer mechanism/base forming a water tight seal which prevents water flowing through the orifice. A lid which covers the receptacle assembly keeps the hot water from spilling out of the receptacle assembly from the top. When the receptacle assembly is refitted to the timer mechanism/base, the receptacle valve abuts and flowably connects to the acutatable valve in the timer mechanism. Thus, the receptacle can be located above the timer mechanism/base, allowing for a simpler, less complicated and more reliable method of releasing the brewed tea than other tea makers, such as described in U.S. Pat. No. 6,802,246.

To keep to a specific tea infusion time, it is furthermore arranged that the actuatable valve assembly remains in a closed position during the tea's infusion time, and that after the brewing cycle is complete the actuatable valve moves to an open position allowing brewed tea to flow through an orifice into a vessel.

Another preferred of the invention includes utilizing an agitation assembly to agitate the tea. Most preferably, the invention has an agitating assembly to agitate the tea leaves, and preferably a vibrating assembly that vibrates the basket containing tea leaves for a predetermined time. Agitating the combination of hot water and tea leaves produces tea having an enhanced flavor, as well as other health benefits. It is believed that the agitation of the tea while it's brewing vastly increases the amount of polyphenols which are potent antioxidants that may fight blood clots and clogged arteries. Other tea makers in the prior art such as U.S. Pat. No. 4,779,720 teach movement of a flavor containing portion of a hot beverage maker, however do not teach the particular features of the present invention.

Because of the tea maker's small size, there is no need to use a large container or carafe for receiving the brewed tea. The filling of a tea cup prevents the tea from cooling off too much, as when it is put into an intermediate storage in a carafe or jug. This reduces the complexity and the cost of the tea maker, and helps make the unit more affordable.

It is therefore an object of the invention to provide a method of controlling the amount of time a single cup of tea is brewed.

It is another object of the invention to provide a tea maker where the user determines the brewing cycle for a cup of tea.

It is also an object of the invention to teach a tea maker that has a removable receptacle, for transporting hot water or for cleaning.

Another object of the invention is to teach a tea maker that does not rely on external power requirements for heating elements or hot plates.

One object of the invention is to provide a simple, affordable tea maker for brewing individual cups of tea.

It is another object of the invention to provide a tea maker having a simplified mechanism for releasing the brewed tea from the receptacle to a vessel.

It is a further object of the invention to teach a tea maker having a receptacle located above a timer mechanism and base.

Furthermore, it is an object of the invention to have teach a tea maker having an improved acuatable valve.

An object of the invention is to teach a method of agitating tea while it is brewing.

It is yet another object of the invention to teach a tea maker having a vibrating basket filter.

Also, it is an object of the invention to teach a tea maker having an electronic timer.

The embodiments of this invention are illustrated in the accompanying drawings and will be described in more detail herein below.

### SUMMARY OF THE INVENTION

A tea maker, comprising a receptacle supported by a base, the receptacle being suitable for receiving water from a user and suitable for containing tea leaves, an actuatable valve having open and closed positions flowably connected to said receptacle; and a timer mechanism which sets the acuatable valve into the open position after a predetermined period set by the user, thereby allowing brewed tea to flow from the receptacle into a tea vessel. The tea maker may also have a device for agitating tea, and most preferably a vibrating basket filter.

### BRIEF DESCRIPTION OF THE DRAWINGS

FIG. 1 is a perspective view of a preferred embodiment of the invention, showing a receptacle assembly, timer mechanism and base.

FIG. 2 is a front view of a preferred embodiment of the invention, showing a receptacle assembly, timer mechanism and base.

FIG. 3 is a right side view of a preferred embodiment of the invention, showing a receptacle assembly, timer mechanism and base.

FIG. 4 is a left side view of a preferred embodiment of the invention, showing a receptacle assembly, timer mechanism and base.

FIG. 5 is a top view of a preferred embodiment of the invention, showing a receptacle assembly.

FIG. 6 is a bottom view of a preferred embodiment of the invention, showing a base.

FIG. 7 is a rear view of a preferred embodiment of the invention, showing a receptacle assembly, timer mechanism and base.

FIG. 8 is an exploded perspective view of a preferred embodiment of the invention, showing a basket, a receptacle assembly removed from the timer mechanism, and the base.

FIG. 9 is an exploded perspective view of a preferred embodiment of the invention, showing an exploded view of the receptacle assembly, an exploded view of the timer mechanism and an exploded view of the base.

FIG. 10 is a front view of a preferred embodiment of the invention showing the movement of the turn handle during operation of the invention.

FIG. 11 is a front perspective view of a preferred embodiment of the invention, showing another embodiment with an electronic timer and an agitation assembly in the form of a vibrating basket filter.

FIG. 12 is a partially exploded front perspective view of the preferred embodiment shown in FIG. 11, further illustrating how the basket filter connects with the vibrating assembly.

FIG. 13 is an exploded view of a preferred embodiment shown in FIG. 11.

### DESCRIPTION OF THE PREFERRED EMBODIMENTS

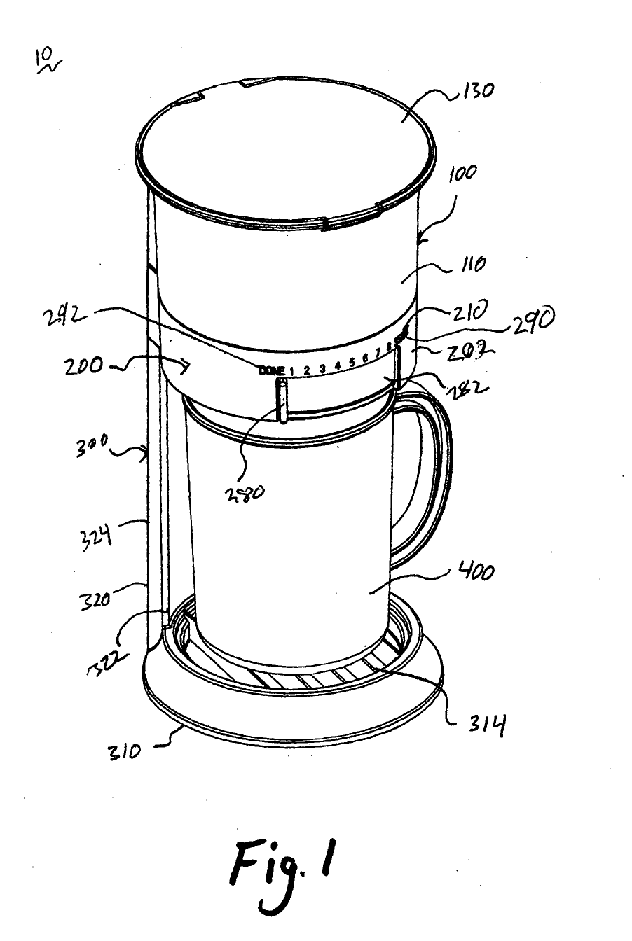

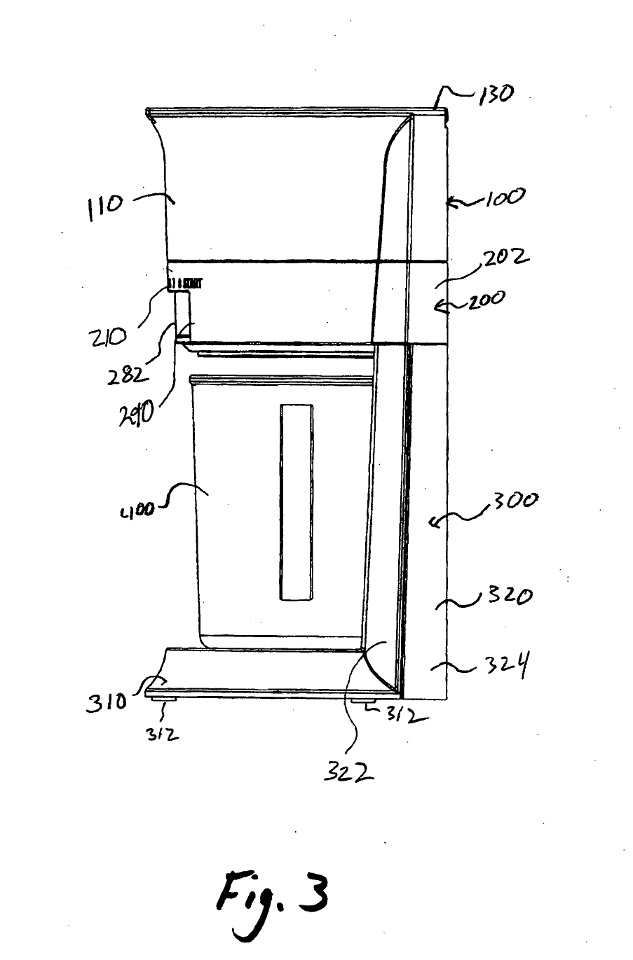

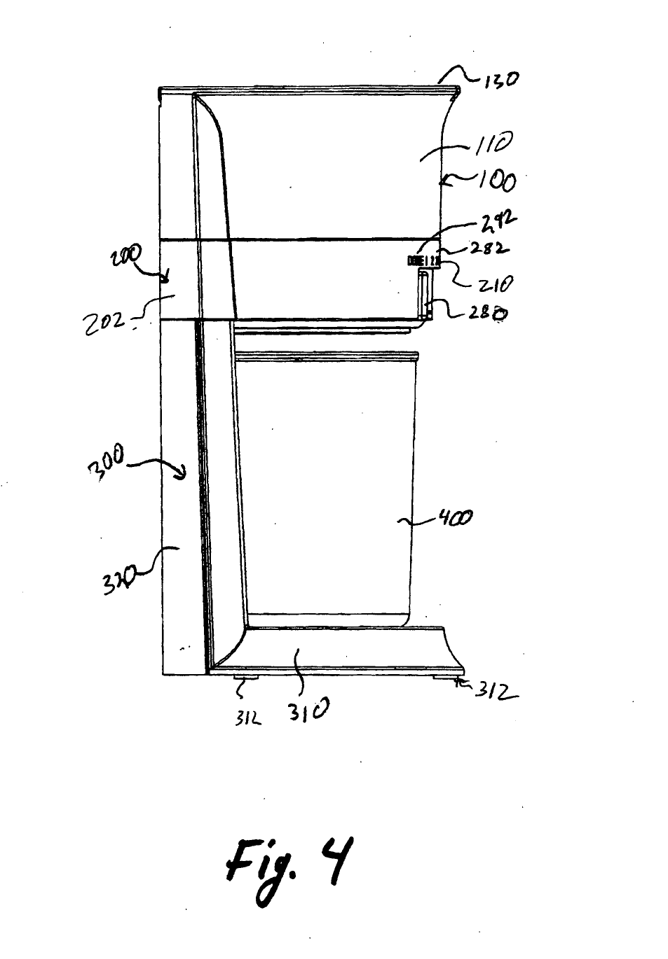

The preferred embodiments of the present invention will now be described with reference to FIG. 1-13 of the drawings. Identical elements in the various figures are identified with the same reference numerals.

Referring now to the drawings, FIG. 1, shows the invention 10, having receptacle assembly 100, timer mechanism assembly 200, and base 300.

Receptacle assembly 100, has receptacle 110, and top cover 130. Timer mechanism assembly 200 has timer cabinet 202, handle 280 and rotator 282. Base assembly 300 has bottom 310, ribs 314, support 320, support front 322, and support rear 324. Also shown resting on bottom 310 is vessel 400. FIG. 1 also shows marks 210, start position 290 and done position 292.

The individual components of the invention, such as receptacle assembly 100, timer mechanism assembly 200 and base 300 can be made of any suitable material such as metal, plastic or glass, but are preferably molded from plastic, more preferably high impact plastics such as polypropylenes or polystyrenes. The materials can be dyed or colored or can be transparent or translucent, and should be able to routinely withstand temperatures of at least 212 degrees Fahrenheit.

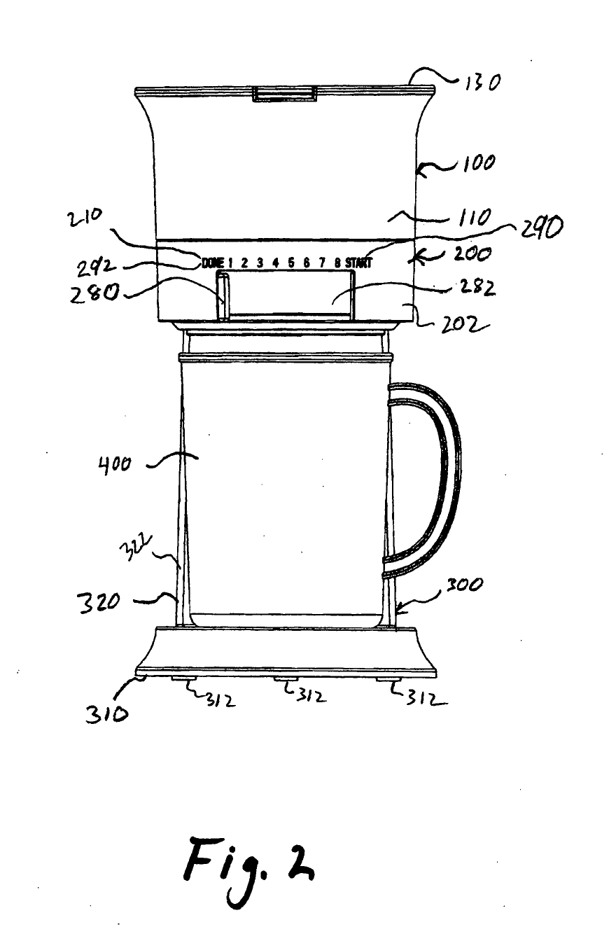

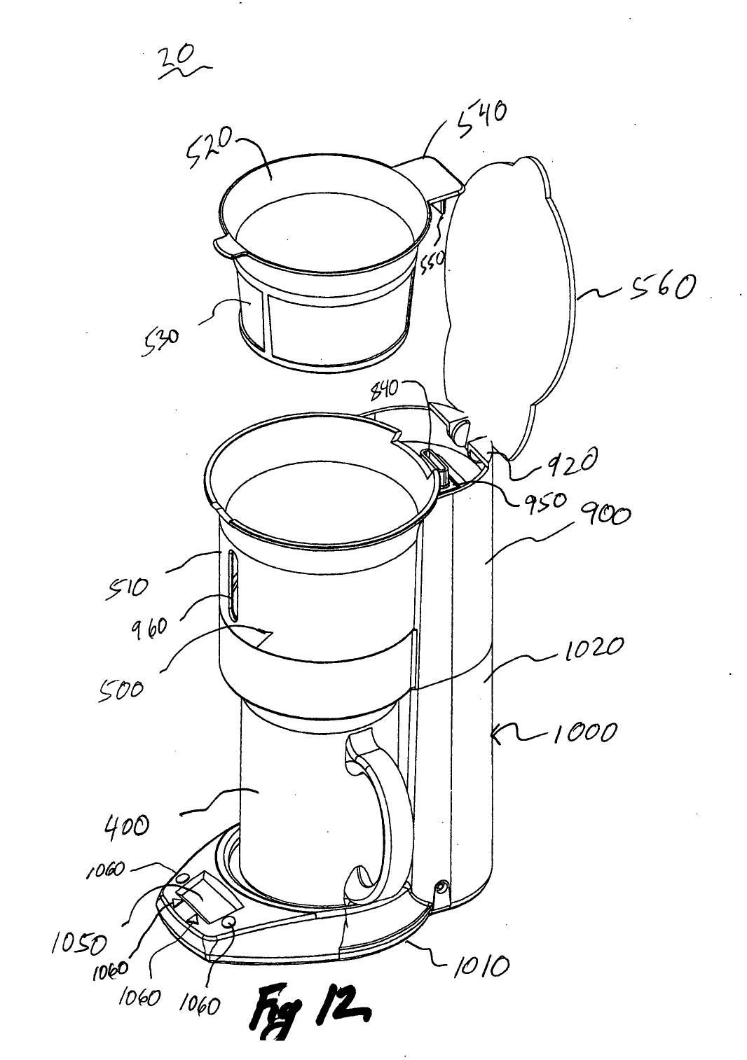

FIGS. 2 to 4 shows receptacle assembly 100, having receptacle 110, and top cover 130. The receptacles of this invention preferably hold up to 16 ounces of water, but can hold 32 ounces or more. Timer mechanism assembly 200 has timer cabinet 202, handle 280 and rotator 282. Base assembly 300 has bottom 310, grommets 312, ribs 314, support 320, support front 322, and support rear 324. Also shown resting on bottom 310 is vessel 400. FIG. 12 also shows marks 210, start position 290 and done position 292.

Vessel 400 can be any cup or container suitable for drinking tea. It could be designed and packaged to compliment the design features of the invention, or the user could supply a cup of his or her choice.

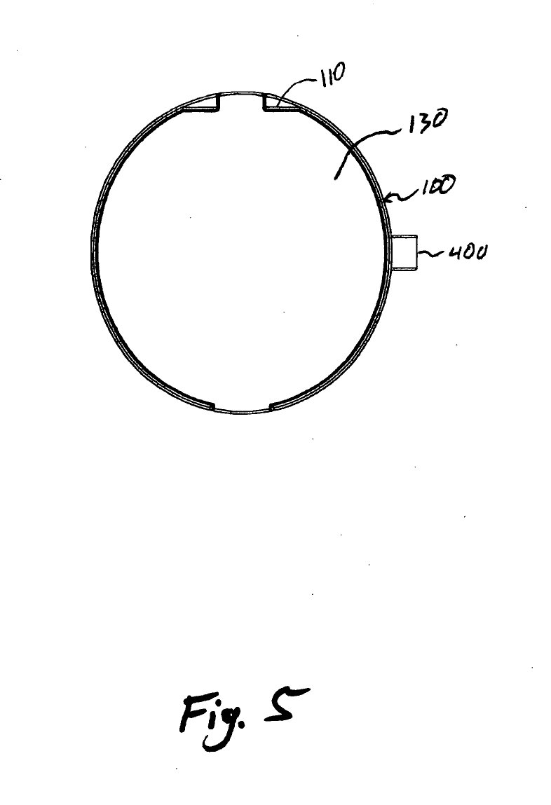

FIG. 5 shows lid 130, receptacle assembly 100, receptacle 110 and vessel 400.

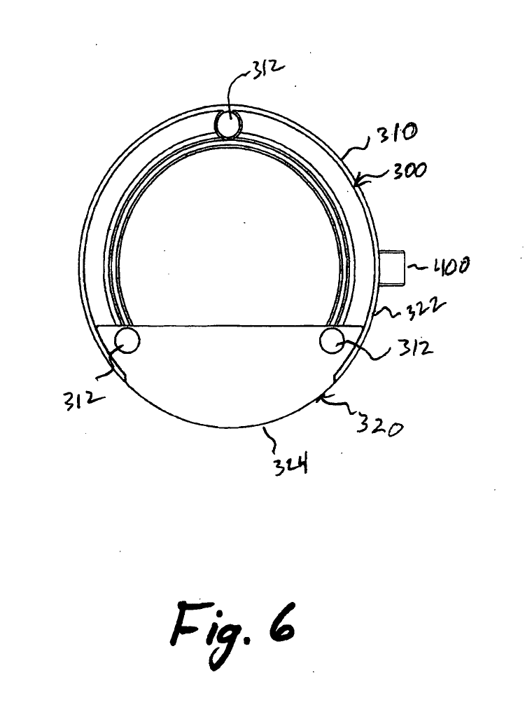

FIG. 6 shows base 300, bottom 310, grommets 312, support 320, support front 322, support rear 324, and vessel 400.

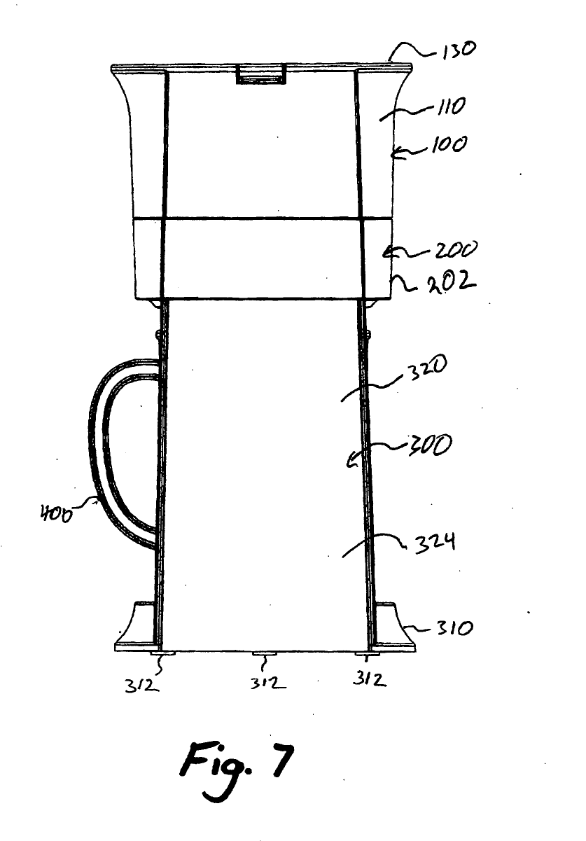

FIG. 7 is a rear view showing receptacle assembly 100, having receptacle 110, and top cover 130. Timer mechanism assembly 200 has timer cabinet 202. Base assembly 300 has bottom 310, grommet 312, support 320, and support rear 324. Also shown resting on bottom 310 is vessel 400.

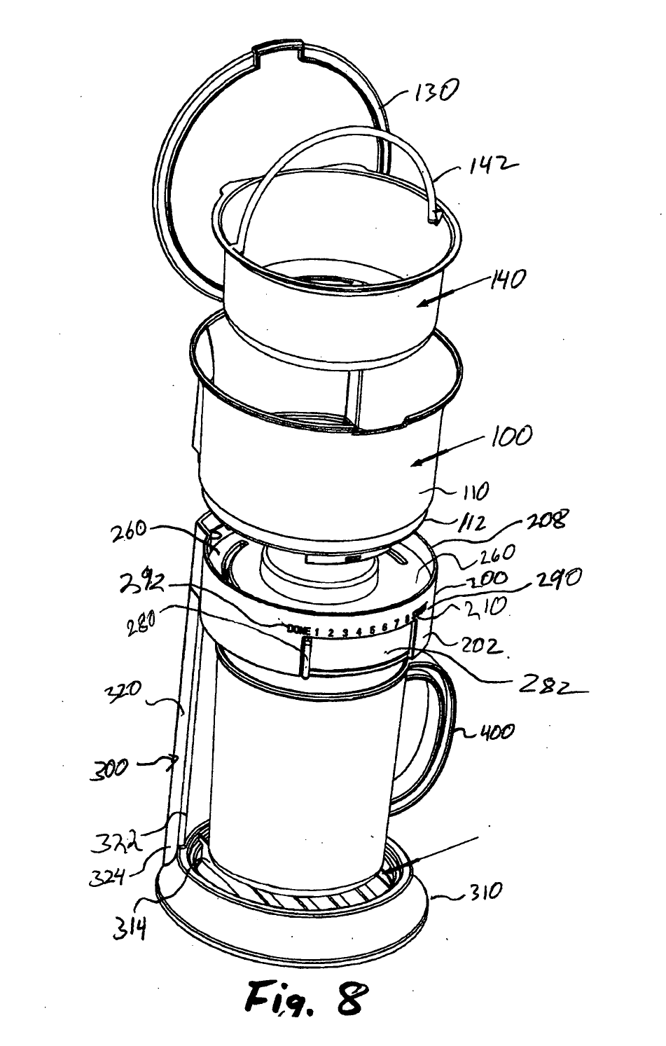

FIG. 8 is an exploded perspective view showing receptacle assembly 100, receptacle 110, positioning groove 112, and top cover 130. Also seen are basket filter 140 and basket handle 142. Timer mechanism assembly 200, has timer cabinet 202, cabinet lip 208, timer marks 210, with start position 290 and done position 292. Timer mechanism assembly 200 has mechanism timer cover 260, turn handle 280, rotator 282, base assembly 300, bottom 310, ribs 314, support 320, support front 322 and support rear 324. Also seen is vessel 400.

Positioning groove 122 allows receptacle assembly 100 to be conformingly fitted into timer mechanism assembly 200. Timer mechanism assembly 200 has cabinet lip 208. When the user desires to place receptacle assembly 100 into timer mechanism assembly 200, say after the receptacle has been removed for cleaning in a dishwasher, the user aligns positioning groove 122 with cabinet lip 208, and slides the receptacle assembly 100 into the timer mechanism assembly 200.

The purpose of optional basket 140 is to contain tea leaves, and to allow the easy placement and removal of tea leaves to and from the receptacle 110. It should be designed to allow water to flow through the tea and into the receptacle 110. It can be constructed in any number of configurations and materials. For example, basket 140 could be made of plastic or metal, could have sides with or without holes, and/or bottoms with or without holes. It can be constructed of a single piece of molded plastic or multiple pieces, or it could be constructed of a metal mesh material. Basket 140 may also have a handle 142, as seen in FIG. 8, however, the handle can be of any suitable configuration. As an alternative to basket 140, the user may use disposable filter made from paper or the like.

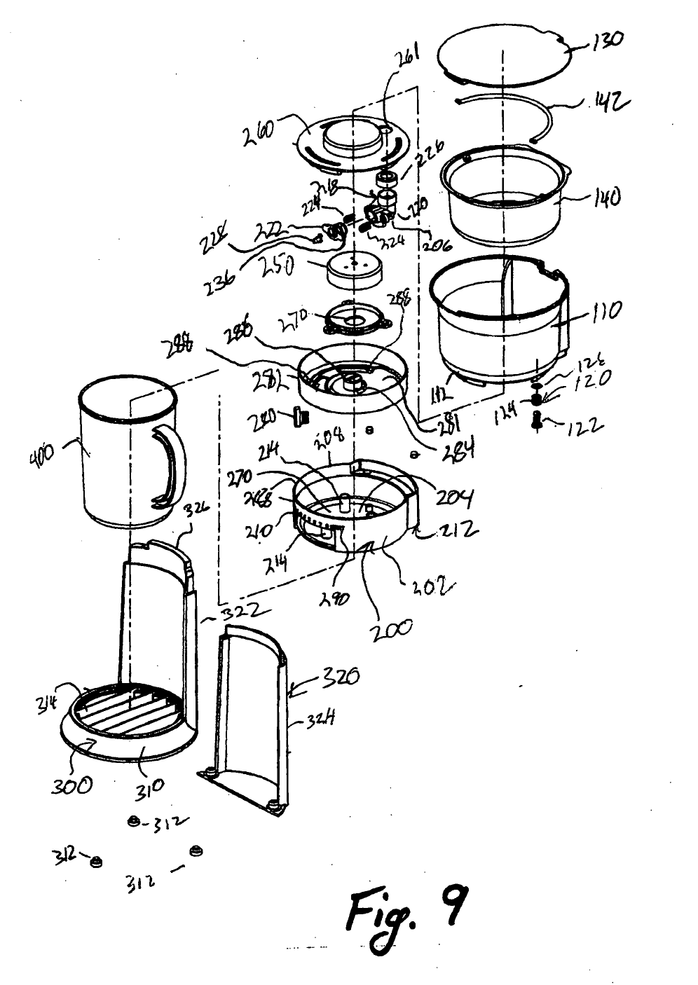

FIG. 9 shows receptacle assembly 100 having receptacle 110, positioning groove 112, top cover 130, basket filter 140, and basket handle 142. Optional receptacle water valve 120 has water valve pole 122, tank spring 124, and tank o ring 126. Valve pole 122 has valve cap 121. In a preferred configuration, tank spring 124 is placed around water valve pole 122, and inserted from below the receptacle 110 into an orifice (not shown) in receptacle 110. O ring 126, or other fastening means is put over valve cap 121, and prevents tank spring 124 from pushing valve pole out of the orifice, retaining valve pole 122. The tank spring 124 forces valve cap 121 against the bottom of receptacle 110, sealing receptacle 110 when it is full of water.

Receptacle valve 120 is positioned so that when receptacle assembly is fitted to timer mechanism assembly 200, it mates with actuatable valve 220. When the receptacle valve mates with actuatable valve 220, it is pushed up, against the force of tank spring 124. This puts receptacle valve 120 into the open position. In this position water or brewed tea can flow from the receptacle 110 through receptacle valve 120, and into acutatable valve 220.

Actuatable valve 218 has valve casing 220, valve shaft 222, springs 224, rubber seal 226, valve shaft pin 228, spring water valve 230, small o ring 236, and drain orifice 206. Valve casing 220 has only one moving part, valve shaft 222, and it is contained within the valve casing 220. No other parts are necessary. This makes opening and closing the acutatable valve 218 simple, straightforward and reliable. Valve shaft 222 fits into valve casing 220, with springs 224 applying opposing force. Valve shaft pin 228 is attached to valve shaft 222, and can be a separate piece as shown or integrally molded onto valve shaft 222. When valve shaft pin 228 is pushed in a direction opposing the force of springs 224, the acutatable valve 218 is in the open position, and fluids can pass through the actuatable valve 218 through drain orifice 206 and into vessel 400. When pressure against valve shaft pin 288 is relieved, the springs 224 expand and move valve shaft 222 into the closed position, preventing fluids from passing through actuatable valve 218 and into vessel 400.

Timer mechanism assembly 200 has timer cabinet 202, timer cabinet bottom 204, cabinet lip 208, timer marks 210, recess 212, posts 214, timer 250, timer cover 260, timer bottom 270, turn handle 280, cavity 281, rotator 282, cam 284, timer catch 286, post slot 288. Also shown are start position 290 and done position 292. It also has actuatable valve 218.

Timer mechanism assembly 200 has timer cabinet 202. Rotator 282 rests on timer cabinet bottom 204. Rotator 282 has attached turn handle 280, which can be integrally molded with rotator 282 or attached separately as shown. When a user exerts lateral force on turn handle 280, rotator 282 moves right or left, as far as start position 290 or done position 292. Timer cabinet 202 also has posts 214. Posts 214 are likely molded into timer cabinet 202, and are fastened to timer bottom 270. Rotator 282 has post slots 288 which allow rotator 282 to move without interfering with posts 214. Timer 250 rests on timer bottom 270. Timer 250 mates with timer catch 286 on rotator 282, so that when turn handle 280 is moved, catch 286 engages timer 250, rotating the timer with it. Acutatable valve 218 attaches to timer cabinet bottom 204. Rotator 282 has cavity 281 to accommodate actuatable valve 218 when rotator 282 rotates. Timer cover 260 has an orifice 261 that mates with acutatable valve 218 at seal 226.

Rotator 282 also has cam 284. When timer mechanism assembly 200 is assembled, cam 284 abuts valve shaft pin 228. Movement of cam 284 opens and closes actuatable valve 218. Cam 284 is most likely designed so that when the user rotates rotator 284 to the far right with turn handle 280, to start position 290, the cam 284 allows acutatable valve 218 to move to a closed position. When the user releases turn handle 280, the timer 250 begins to turn, moving rotator 284 laterally to the left. When turn handle 280 reaches done position 292, cam 284 allows acutatable valve 218 to open releasing tea from receptacle 110. Optionally, timer mechanism assembly 200 can have a catch that holds turn handle 280 in the start position 290 indefinitely, until the user moves it a predetermined distance to the left.

Base assembly 300 has bottom 310, grommets 312, ribs 314, support 320, support front 322, support rear 324, support projection 326 and vessel 400. Support 320 can be separate molded pieces, comprising support front 322 and support rear 324, or a single integrally molded piece, or multiple molded pieces. Support projection 326 fits into recess 212, connecting base assembly 300 to timer mechanism assembly 200. Base 300 has optional ribs 314. Ribs 314 can catch extra water or tea that spill from vessel 400 or from timer mechanism assembly 200 or receptacle assembly 100. The ribs 314 allow the water or tea to collect without substantially wetting the bottom of vessel 400. Alternatively, ribs 314 could be replaced with grooves or with a separate molded ring or disk having holes or slots that allow water or tea to flow into a reservoir molded into base 300.

As stated receptacle assembly 100 is preferably removable from timer mechanism assembly 200. When the receptacle assembly 100 is removed from timer mechanism assembly 200, receptacle water valve 120 closes. This allows the user to fill the receptacle assembly 100 with water, and transport the filled receptacle assembly 100 to timer mechanism assembly 200 and base assembly 300 without water leaking out of receptacle assembly 100. In addition, if receptacle assembly 100 is removable, then it can be cleaned easily, either by hand or in a dishwasher. Optional lid 130, if closed, can keep hot water from spilling out of receptacle 110, when being moved from the hot water source to the timer mechanism/base.

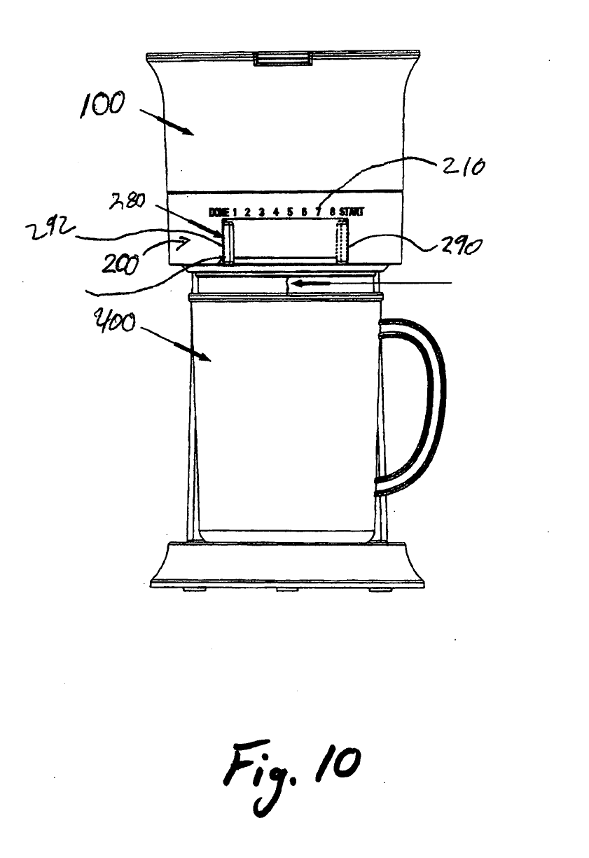

In order to use the preferred present invention, the user places tea leaves in basket 140. The user moves turn handle 280 to the far right hand, ie. start position 290 as seen in FIG. 10. The movement causes rotator 282 to rotate cam 284, positioning it against valve shaft pin 228, putting acutatable valve 218 in the closed position. The user then pours boiling water into receptacle assembly 100, and moves turn handle 280 toward the left to the desired position, using marks 210 on timer bottom 270 as a reference. After releasing turn handle 289, the user waits until rotator 282 moves to the far most right position, i.e., done position 292. When in the done position 292, cam 284 activates actuatable valve 218 to the open position, allowing the brewed tea to flow through to vessel 400. A preferred brewing time is about 3 minutes, with a typical brewing range being between 1 and 5.5 minutes, depending on the preference of the user. Marks 210 should be correlated with the elapsed time of timer 250, so that, for example moving the turn handle 284 to the 3 minute mark corresponds to a brewing time of 3 minutes. Of course, other embodiments are possible and the method of opening and closing the actuatable valve 218 can be accomplished in any number of ways which would be apparent to the skilled artisan.

For example an electronic timer having solenoid actuated valves, could be substituted for the mechanical timer. Other configurations, activating mechanisms, gates, valves etc would be apparent to the skilled artisan and are expected to fall within the scope of the invention described herein, so long as they rely on variations of an acuatable valve similar to the one described herein.

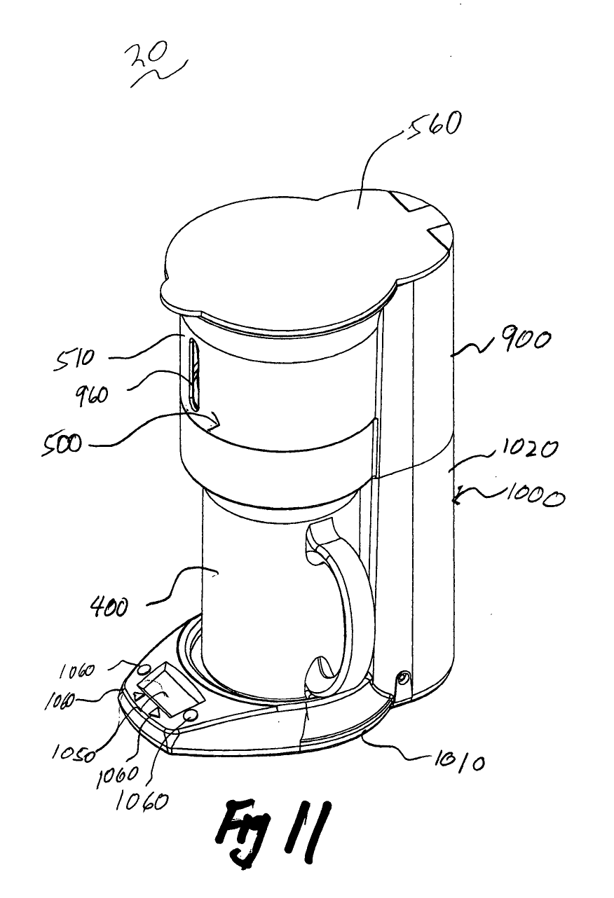

FIGS. 11 to 13 show an additional preferred embodiment 20 of the invention. As will be seen, embodiment 20 has an agitation assembly in the form of a vibrating assembly 800 which agitates basket filter 520, thereby enhancing the flavor and health benefits of the tea.

FIG. 11 shows receptacle assembly 500, top cover 560, mechanical support 900, window 960, base assembly 1000, bottom 1010, support 1020, electronic timer 1050, buttons 1060 and vessel 400.

FIG. 12 shows receptacle assembly 500, receptacle 510, basket filter 520, basket screen 530, basket handle 540, basket rib 550, top cover 560, basket rib interaction 840, mechanical support 900, top hinge 920, seal 950, window 960, base assembly 1000, bottom 1010, support 1020, electronic timer 1050, buttons 1060 and vessel 400.

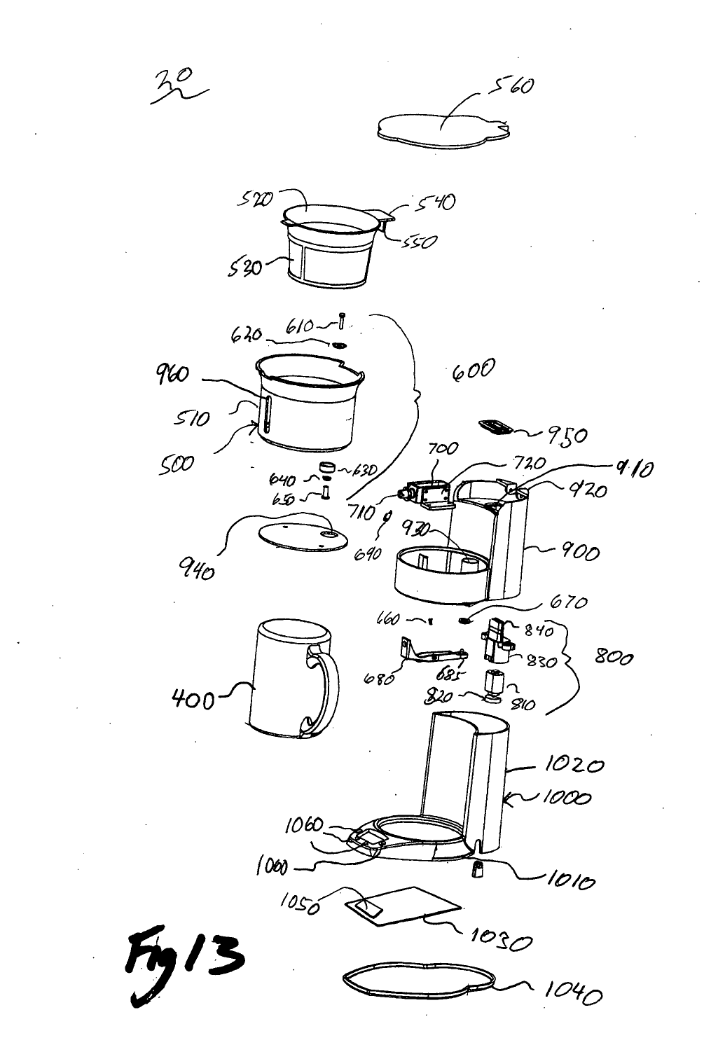

FIG. 13 shows receptacle assembly 500, receptacle 510, basket filter 520, basket screen 530, basket handle 540, basket rib 550, top cover 560, Also seen is valve assembly 600, having valve stem 610, valve cover 620, water tank seal 630, water valve spring 640, retainer 650, counter spring 660, valve seal 670, rocker arm 680, rocker arm end 685, rocker arm link 690, solenoid 700, and solenoid piston 710, angle bracket 720, Vibrating assembly, 800, is also seen and has motor 810, counter weight 820, motor housing 830, basket rib interaction 840, Mechanical support 900, seal receptacle 910, top hinge 920, cover hole 940, seal 950, window 960, base assembly 1000, bottom 1010, support 1020, circuit board 1030, sub base 1040, electronic timer 1050, buttons 1060 and vessel 400 are also shown.

Receptacle 510, mechanical support 900, and base assembly 1000 are preferably made of the same materials as embodiment 10, such as polypropylene. Moreover, it is highly preferred that receptacle 510 remains stationary and does not oscillate or vibrate while the tea is brewed, except as it is incidental to the vibrations caused by the movement of basket filter 520.

The agitation assembly can be any assembly that agitates tea in receptacle 510. The most preferred method of agitation is to use a vibrating assembly 800 as seen in the drawings and as discussed below. However, other methods of agitation are also contemplated, such as utilizing a mechanical stirring mechanism, or an ultrasonic generator which has a pizza electric vibrating device. Alternatively, a motor could be placed in various locations within the receptacle or mechanical support to impart motion to the receptacle.

Basket filter 520, can be made of any suitable material, but is most likely made out of plastic or metal. Basket screen 530 is preferably is made containing a screen type material with a mesh sufficient to hold tea leaves but also porous enough to allow water to flow through the screen into the receptacle 510. Typical screen materials are aluminum, fiberglass, plastic or cloth. The basket filter 520 can be made in any configuration and can for example, be a solid piece of plastic with holes drilled in it. The actual configuration and materials are not so critical, so long as this component fulfills the purpose of containing tea leaves and allowing water to flow through during brewing.

Basket handle 540 is seen in FIGS. 12 and 13. In a preferred embodiment, basket handle 540 is removably connected to basket rib interaction 840. Thus, the basket filter 520 can be removed from receptacle assembly 500 to be cleaned or to be filled with tea leaves. When the basket filter 520 is reinserted into receptacle assembly 500, then basket handle 540 having basket rib 550 fits easily and smoothly into basket rib interaction 840. This connection allows vibrating assembly 800 to agitate the basket filter 520. The actual nature of the connection between basket filter 520 and vibrating assembly 800 is not critical, so long as basket filter 520 can be removed or reconnected to vibrating assembly 800 as desired by the user, and the connection between basket filter 520 and vibrating assembly 800 is sufficient to transmit energy from vibrating assembly 800 to basket assembly 520, allowing agitation of the tea water mixture in basket filter 520. Note also that mechanical support 900 has seal 950 disposed in seal receptacle 910. Seal 950 forms around housing 840, and allows housing 840 to vibrate, yet prevents water from leaking into mechanical support 900.

Instead of the removable basket filter 520 shown in the drawings, vibrating assembly 800 could be affixed to a support (not shown). The support could contain or secure basket filter 520, and the basket filter 520 could be removable for cleaning and rinsing. However, the preferred configuration is for basket filter 520 to connect directly to the basket rib interaction 840.

An exploded view of a possible vibrating assembly 800 configuration is shown in FIG. 13. The vibrating assembly has motor 810. Motor 810 can be any motor suitable for the purposes of the invention. The preferred motor preferably rotates at between 1,000 and 10,000 revolutions per minute. While the motor shown in FIG. 13 is regulated by circuit board 1030 which is in turn powered by an AC cord (not shown), it is also contemplated that the motor could be DC powered and operated by batteries. The batteries could be rechargeable or disposable.

Vibrating assembly 800 also has counter weight 820. Counter weight 820 is connected to the armature of motor 810. Counter weight 820 as shown in FIG. 13 is a partial disk. When motor 810 is powered and the motor's armature rotates, the imbalance caused by the partial disc configuration of counter weight 820 causes motor and attached motor housing 830 to wobble. Motor 810 vibrates along with motor housing 830. The energy of vibration from vibrating housing 830 is transmitted through basket rib interaction 840, thereby creating a vibrating basket filter 520. It should be obvious is one skilled in the art that numerous variations of the vibrating assembly 800 could be contemplated, such as positioning the motor in a different place, or using a different type of counter weight to create the desired vibration. For example, one possibility would be for the counter weight to push against a solid surface located within mechanical support 900. As shown in FIG. 13 the time and duration of the vibration of vibration assembly 800 is controlled by electronic timer 1050. However the duration of such a vibration could also be controlled manually by a user by pressing buttons 1060. Also, the vibration could be controlled using a simple on-off switch (not shown) either electrical or mechanical that is operated by the user.

An exploded view of valve assembly 600 is seen in FIG. 13. Valve assembly 600 opens and closes as appropriate to allow tea to flow from receptacle assembly 500 into vessel 400. This flow can be controlled by electronic timer 1050 or manually through access buttons 1060. While the drawings show that valve assembly 600 is controlled electronically via electronic timer 1050, it is also contemplated that valve assembly 600 could be operated mechanically. As seen in FIG. 13, the valve is opened and closed by actuating solenoid piston 710. Solenoid piston 710 is contained within solenoid 700 which is attached to mechanical housing 900 using angle bracket 720. Also seen is rocker arm 680 which is linked to solenoid piston 710 with rocker arm link 690. When solenoid piston 710 retracts into solenoid 700, rocker arm link 690 is pulled, exerting a force on rocker arm 680. The force on rocker arm 80 causes rocker arm end 685 to move downward allowing retainer 650 to also move downwards, via the force applied by water valve spring 640. This allows brewed tea to flow through a hole (not seen) through the bottom of the receptacle assembly 500, through channel 930 and into vessel 400.

The valve assembly 600 described above is only one of many possible ways to allow liquid disposed in receptacle assembly 500 to flow into a vessel 400, and skilled artisans will immediately see that many different valve assembly configurations are possible; it is contemplated by the present inventors that all such variations are within the scope of the present invention.

As seen in the figures, embodiment 20 has electronic timer 1050. Electronic timer 1050 can have any number of different controls or attributes. For example, electronic timer 1050 can control the amount of time that basket filter 520 vibrates. An ideal amount of time for such vibration is about 1 to 5.5 minutes, with 3 minutes being most preferred. In a preferred embodiment, this time period can be set by a user. Ideally, electronic timer 1050 is programmed to activate valve assembly 600 when electronic timer 1050 shuts off vibration assembly 600. After a predetermined period, preferably about 10 to 20 seconds, electronic timer 1050 deactivates valve assembly 600, automatically closing the valve assembly and readying the invention 20 for its next use. The predetermined time for this step is based on the size of the receptacle and how quickly the fluid drains therefrom and may be adjusted accordingly. A preferred embodiment, this time period can also be set by the user. Electronic timer 1050 can also include manual override functions, so the user could start or stop the vibration at will, or open or close the valve assembly at will. Electronic timer 1050 can also include a preprogrammed subroutine that allows for the timer to be set to activate vibration assembly 800 at some predetermined time in the future. Electronic timer 1050 can also display the time of day and or date when the unit is not in use, and can also contain an LED which lights the assembly so that the commands can be seen in a dark room.

It's important to note that the invention provides a very simple and economical method of brewing tea. The construction is simple and straight forward.

While the invention as shown is suitable for brewing a single cup of tea, it is possible to construct larger units capable of brewing 2, 3 or more cups simultaneously, adapting the principles of the invention as articulated herein. Also, while the preferred embodiments of the invention described herein do not disclose the use of heating elements, it will be clear to the skilled artisan that a heating element or elements may be desirable in some embodiments of the invention.

Although this invention has been described with a certain degree of particularity, it is to be understood that the present disclosure has been made only by way of illustration and that numerous changes in the details of construction and arrangement of parts may be resorted to without departing from the spirit and the scope of the invention.

We claim:

1. A tea maker, comprising:
a stationary receptacle supported by a base assembly, the receptacle having a basket suitable for receiving water and suitable for containing tea leaves;
a valve assembly having open and closed positions flowably connected to said receptacle; and
an agitation assembly which agitates the basket.

2. The tea maker of claim 1, wherein the agitation assembly is a vibrating assembly.

3. The tea maker of claim 1, wherein an electronic timer determines the amount of time the agitation assembly agitates.

4. The tea maker of claim 1, wherein the basket is removably connected to the agitation assembly.

5. The tea maker of claim 1, wherein the water is heated by a user before being poured into said receptacle.

6. The tea maker of claim 1, wherein the receptacle holds up to 16 ounces of water.

7. The tea maker of claim 1, wherein the tea maker further comprises a vessel for receiving tea.

8. The tea maker of claim 1, wherein an electronic timer opens and closes a valve in the valve assembly.

9. The tea maker of claim 1, wherein the basket agitates about 1 to 5.5 minutes.

10. The tea maker of claim 1, wherein the valve assembly is actuated by a solenoid piston.

11. The tea maker of claim 1, wherein the basket is removably connected to the vibrating assembly with a basket rib.

12. The tea maker of claim 2, wherein the vibrating assembly has a motor, and the motor has a counter weight.

13. The tea maker of claim 12, where in the motor has a speed of from 1000 to 10,000 rpm.

14. The tea maker of claim 1, wherein the tea maker contains a heating element.
